(19) United States
(12) Patent Application Publication
(10) Pub. No.: US 2024/0347851 A1
(43) Pub. Date: Oct. 17, 2024

(54) BATTERY DEVICE AND BATTERY SYSTEM INCLUDING THE SAME

(71) Applicant: SK On Co., Ltd., Seoul (KR)

(72) Inventors: Jin Woo SON, Daejeon (KR); Dong Min KIM, Daejeon (KR); Chae Won NA, Daejeon (KR); Hyo Seong AN, Daejeon (KR)

(21) Appl. No.: 18/634,341

(22) Filed: Apr. 12, 2024

(30) Foreign Application Priority Data
Apr. 13, 2023 (KR) 10-2023-0048845

(51) Int. Cl. H01M 50/383; H01M 50/211; H01M 50/24; H01M 50/271; H01M 50/342; H01M 50/375; H01M 50/507

(52) U.S. Cl. CPC H01M 50/383; H01M 50/211; H01M 50/24; H01M 50/271; H01M 50/3425; H01M 50/375; H01M 50/507

(57) ABSTRACT

A battery device includes a cell assembly; a case accommodating the cell assembly; and at least one venting portion in the case to discharge gas generated from the cell assembly to the outside of the case; wherein the at least one venting portion includes a hole cover surrounded by a first region formed by cutting a surface of the case and a second region connected to a surface of the case, and a sealing member covering the first region, wherein the hole cover is lifted from a surface of the case and comprises a venting hole in the at least one venting portion, and wherein the sealing member seals the first region to prevent gas from flowing through the first region in a state in which the hole cover covers the venting hole.

### CROSS-REFERENCE TO RELATED APPLICATION(S)

This patent document claims the priority and benefits of Korean Patent Application No. 10-2023-0048845 filed on Apr. 13, 2023, the disclosure of which is incorporated herein by reference in its entirety.

### TECHNICAL FIELD

The technology and implementations disclosed in this patent document generally relate to a battery device including a cell assembly including a plurality of battery cells and a battery system including the same.

### BACKGROUND

Unlike a primary battery, a secondary battery may be charged and discharged such that secondary battery may be applied to devices in various fields such as a digital camera, a mobile phone, a laptop, a hybrid car, an electric car, and an energy storage system (ESS). A secondary battery may include a lithium ion battery, a nickel-cadmium battery, a nickel-metal hydride battery, or a nickel-hydrogen battery.

A secondary battery may be manufactured to include flexible pouch-type battery cells or rigid prismatic or cylindrical may-type battery cells. A plurality of battery cells may be formed as a stacked cell assembly.

The cell assembly may be disposed in a module housing and may form a battery module, and a plurality of battery modules may be disposed in a pack housing and may form a battery pack.

### SUMMARY

A battery cell may be ignited in various events such as when a lifespan of a battery cell ends, when a battery cell swells, when a battery cell is overcharged, when a battery cell is exposed to heat, when a sharp object such as a nail breaks an exterior material of a battery cell, or external impact is applied to a battery cell. When a cell assembly including a battery cell ignites, flames or high-temperature gases (including electrolyte gas and combustion substances) emitted from the cell assembly may cause secondary ignition or chain ignition of other adjacent cell assemblies. Also, when flames from a battery module or a battery pack are exposed to the outside, flames may damage other components around a battery module or a battery pack, and other components may lead to secondary ignition (chain ignition).

An aspect of the disclosed technology is to provide a battery device which may induce gases (including flames and combustion substances) generated from a cell assembly in a specific direction, and a battery system including the same.

An aspect of the disclosed technology is to provide a battery device which may delay or prevent gases generated from a cell assembly from being transferred to other cell assemblies or other components, and a battery system including the same.

An aspect of the disclosed technology is to provide a battery device which may delay or prevent secondary ignition and/or thermal runaway of a cell assembly, and a battery system including the same.

According to an aspect of the disclosed technology, a battery device includes a cell assembly including a plurality of battery cells; a case accommodating the cell assembly; and at least one venting portion formed in the case to discharge gas generated from the cell assembly to the outside of the case; wherein the at least one venting portion includes a hole cover surrounded by a first region formed by cutting a surface of the case and a second region connected to a surface of the case, and a sealing member covering the first region, wherein the hole cover is configured to be lifted from a surface of the case in a direction of an external side of the case and to form a venting hole in the at least one venting portion, and wherein the sealing member seals the first region to prevent gas from flowing through the first region in a state in which the hole cover covers the venting hole.

In an embodiment, the venting hole may be formed by a portion surrounded by the first region and the second region when the hole cover is lifted.

In an embodiment, the hole cover may be folded in a direction of an external side of the case with respect to the second region.

In an embodiment, the sealing member may include a material ignited or melting at 100° C. or higher and 400° C. or lower.

In an embodiment, the sealing member may include polypropylene (PP) or polyvinyl chloride (PVC).

In an embodiment, the sealing member may be configured to open the first region when a temperature of the sealing member reaches a set temperature or higher or when pressure applied to the sealing member reaches a set pressure.

In an embodiment, a maximum width of the first region may have a value greater than a length of the second region with respect to a direction parallel to the second region.

In an embodiment, a length of the second region may have a value of 0.1 or more and 0.9 or less with respect to a maximum width of the first region.

In an embodiment, the first region may include a first portion facing the second region with a gap therebetween, a second portion extending from both ends of the first portion toward the second region, and a third portion connecting both ends of the second portion to the second region.

In an embodiment, the first region may include at least a portion of a quadrangular shape, at least a portion of a circular shape, or at least a portion of an elliptical shape.

In an embodiment, at least a portion of the second region may have a thickness smaller than that of the case.

In an embodiment, the hole cover may have a shape lifted in a second direction such that gas passing through the venting hole in a first direction is discharged in the second direction in the state in which the venting hole is open, and the second direction is different from the first direction.

In an embodiment, the case may include an upper plate covering an upper portion of the cell assembly and a side plate covering a side surface of the cell assembly, and the at least one venting portion may be disposed on at least one of the upper plate or the side plate.

In an embodiment, the at least one venting portion may include a plurality of venting portions, and the plurality of venting portions may be configured such that gas discharged from each of the venting portions is directed in the same direction.

In an embodiment, the at least one venting portion may include a plurality of venting portions, and the plurality of venting portions may include a first venting portion disposed in a column, and a second venting portion disposed in a column in a position spaced apart from the first venting portion.

In an embodiment, a first discharge direction in which gas discharged from the first venting portion is directed and a second discharge direction in which gas discharged from the second venting portion is directed may be opposite directions.

In an embodiment, the battery device may further include a busbar assembly including a plurality of busbars electrically connecting the plurality of battery cells to each other, and a connection terminal connecting at least a portion of the plurality of busbars to an external entity, wherein the at least one venting portion is disposed such that gas discharged from each venting portion is not directed toward the connection terminal.

In an embodiment, the battery device may further include a blocking member disposed between the cell assembly and the at least one venting portion and delaying or preventing flames from being discharged through the at least one venting portion.

According to another aspect of the disclosed technology, a battery device includes a cell assembly including a plurality of battery cells; a case accommodating the cell assembly; and at least one venting portion formed in a case to discharge gas generated from the cell assembly to the outside of the case; wherein the at least one venting portion includes a hole cover surrounded by a first region formed by cutting a surface of the case and a second region connected to a surface of the case, and a sealing member covering the first region, wherein the hole cover is configured to be lifted from a surface of the case in a direction of an external side of the case, and wherein the sealing member seals the first region to prevent gas from flowing through the first region and opens the first region when a temperature thereof is a set temperature or higher or pressure is a set pressure or higher.

According to another aspect of the disclosed technology, a battery system includes a housing including an internal space formed therein; and a plurality of battery devices accommodated in the housing, wherein each of the plurality of battery devices includes a cell assembly including a plurality of battery cells; a case accommodating the cell assembly; and at least one venting portion formed in the case to discharge gas generated from the cell assembly to the outside of the case, wherein the at least one venting portion includes a hole cover surrounded by a first region formed by cutting a surface of the case and a second region connected to a surface of the case, and a sealing member covering the first region, and wherein the hole cover is configured to be lifted from a surface of the case in a direction of an external side of the case and to form a venting hole in the at least one venting portion, and wherein the sealing member seals the first region to prevent gas from flowing through the first region in a state in which the hole cover covers the venting hole.

### BRIEF DESCRIPTION OF DRAWINGS

Certain aspects, features, and advantages of the disclosed technology are illustrated by the following detailed description with reference to the accompanying drawings.

FIG. 1 is a perspective diagram illustrating a battery cell according to an embodiment of disclosed technology;

FIG. 2 is an exploded perspective diagram illustrating the battery device illustrated in FIG. 1;

FIG. 3 is an exploded perspective diagram illustrating a portion of components such as a cell assembly and a busbar assembly illustrated in FIG. 2;

FIG. 4 is a plan diagram illustrating an upper plate and a venting portion illustrated in FIG. 1;

FIGS. 5A and 5B are cross-sectional diagrams taken along line I-I′ in FIG. 4, and FIG. 5A illustrates a state in which a hole cover is closed, and FIG. 5B illustrates a state in which a hole cover is lifted and a venting hole is formed;

FIG. 6 is a cross-sectional diagram taken along line II-II′ in FIG. 1, illustrating a state in which a hole cover is lifted;

FIGS. 7A and 7B are plan diagrams illustrating a modified example of a venting portion illustrated in FIG. 4;

FIGS. 8A and 8B are diagrams illustrating another modified example of a venting portion illustrated in FIG. 4, and FIG. 8A is a plan diagram, and FIG. 8B is a cross-sectional diagram taken along line III-III′;

FIGS. 9 and 10 are cross-sectional diagrams each illustrating a modified example in FIG. 6;

FIG. 11 is an exploded perspective diagram illustrating a modified example in FIG. 3;

FIG. 12 is a cross-sectional diagram illustrating another modified example in FIG. 6, illustrating a cross-section of the component illustrated in FIG. 11;

FIG. 13 is a perspective diagram illustrating a battery device according to another embodiment of disclosed technology;

FIG. 14 is a cross-sectional diagram taken along line IV-IV′ in FIG. 13;

FIG. 15 is a cross-sectional diagram illustrating a modified example in FIG. 14;

FIG. 16 is a perspective diagram illustrating a battery device according to another embodiment of disclosed technology; and

FIG. 17 is a plan diagram illustrating a battery system according to an embodiment of disclosed technology.

### DETAILED DESCRIPTION

Features of the disclosed technology disclosed in this patent document are illustrated in embodiments with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure.

In the drawings, same elements will be indicated by same reference numerals. Also, redundant descriptions and detailed descriptions of known functions and elements that may unnecessarily make the gist of the present disclosure obscure will not be provided. In the accompanying drawings, some elements may be exaggerated, omitted or briefly illustrated, and the sizes of the elements do not necessarily reflect the actual sizes of these elements.

In embodiments, in a battery device 100, at least one cell assembly 110 including a plurality of battery cells 120 may be installed in the case 150. In embodiments, the battery device 100 may include a battery module or a battery pack on which at least one cell assembly 110 is installed. Also, in embodiments, the battery device 100 may include a battery pack of a cell-to-pack structure in which at least one cell assembly 110 is installed directly in the case 150 without including a battery module interposed therebetween. Hereinafter, for ease of description, the example in which the battery device is configured as a battery module will be described, but the battery device according to an embodiment may also be applied to a battery pack.

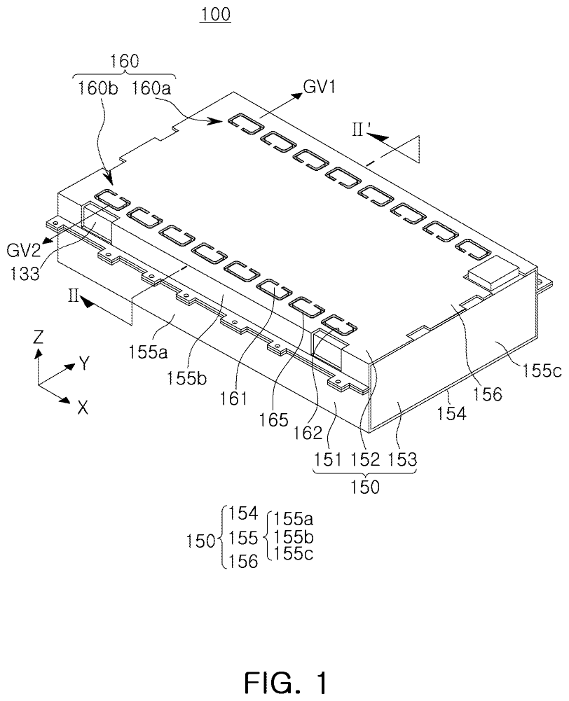

First, the battery device 100 according to an embodiment will be described with reference to FIGS. 1 to 3.

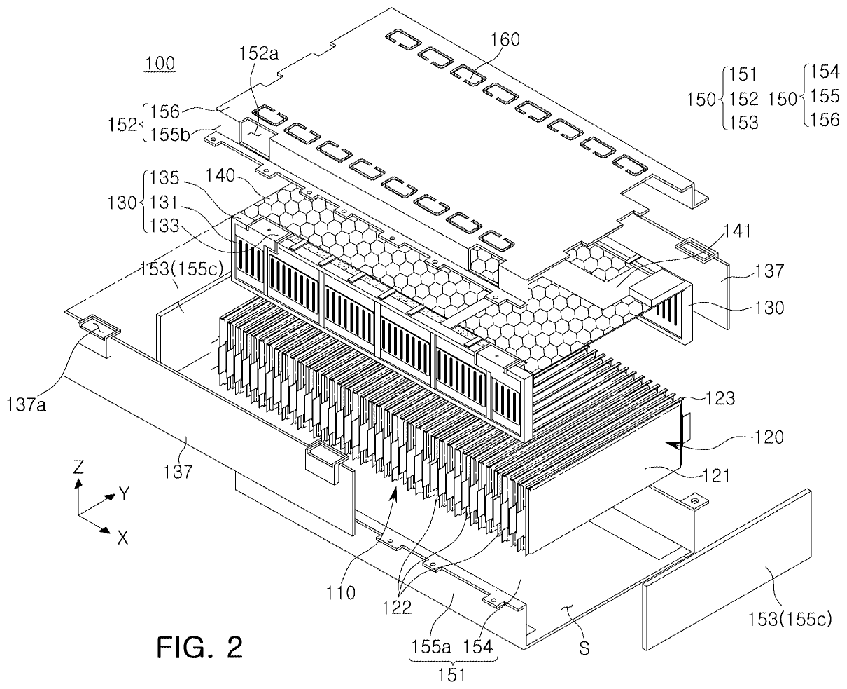

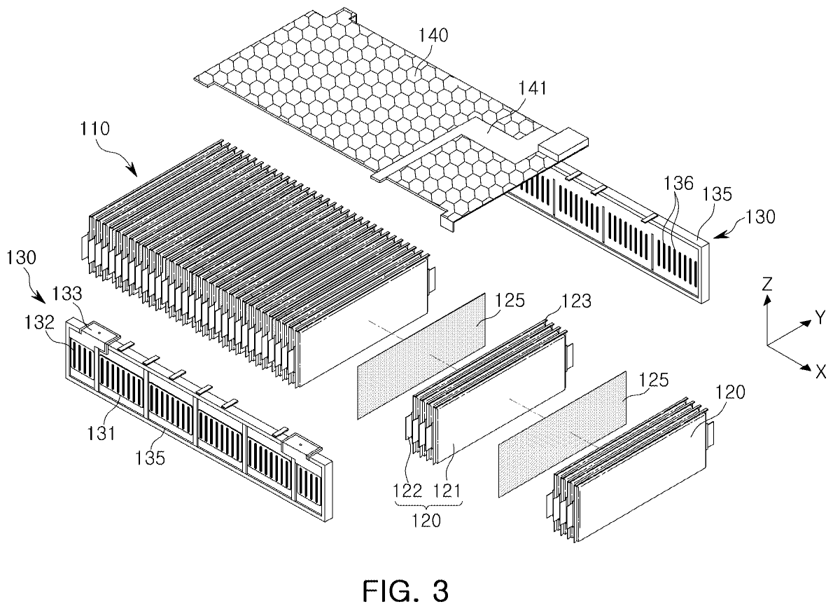

FIG. 1 is a perspective diagram illustrating a battery cell 100 according to an embodiment. FIG. 2 is an exploded perspective diagram illustrating the battery device 100 illustrated in FIG. 1. FIG. 3 is an exploded perspective diagram illustrating a portion of components such as a cell assembly 110 and a busbar assembly 130 illustrated in FIG. 2. FIG. 3 illustrates a state in which the battery cell 120 and the insertion member 125 included in the cell assembly 110 are stacked.

Referring to FIGS. 1 to 3, a battery device 100 according to an embodiment may include a cell assembly 110 including a plurality of battery cells 120, a case 150 accommodating the cell assembly 110, and at least one venting portion 160 formed in the case 150 to discharge gas generated from the cell assembly 110 to the outside of the case 150. Also, the battery device 100 according to an embodiment may include a busbar assembly 130.

The case 150 may form an exterior of the battery device 100 and may protect the cell assembly 110 from an external environment. The case 150 may include an accommodation space S accommodating at least one cell assembly 110.

The case 150 may include a bottom plate 154, a side plate 155, and an upper plate 156. The bottom plate 154 may correspond to a bottom surface of the cell assembly 110, the upper plate 156 may correspond to a top surface of the cell assembly 110, and the side plate 155 may correspond to a plurality of side surfaces of the cell assembly 110. The case 150 may form the accommodation space S surrounded by the bottom plate 154, the side plate 155 and the upper plate 156. Although FIGS. 1 and 2 illustrate the example in which the case 150 covers six surfaces of the accommodation space S, the case 150 may have a shape in which at least one surface of accommodation space S is in an open state.

The bottom plate 154, the side plate 155 and the upper plate 156 may have a shape in which at least a portion thereof may be integrated. For example, the first case 151 may have a structure in which a bottom plate 154 and two first side plates 155a extending upwardly from the bottom plate 154 are integrated. The second case 152 may have a structure in which the upper plate 156 and two second side plates 155b extending downwardly from the upper plate 156 are integrated. In this case, each of the first case 151 and the second case 152 may have a U-shaped cross-section. The first case 151 and the second case 152 may be coupled to each other and may have a shape in which both ends are open. The first side plate 155a and the second side plate 155b may be coupled to each other through a generally used fastening means. The third case 153 may cover both open ends of the first case 151 and the second case 152. The third case 153 may cover the open portion in the state in which the first case 151 and the second case 152 are coupled to each other. The third case 153 may be included in a third side plate 155c. The third case 153 may connect the upper plate 156, the bottom plate 154, the first side plate 155, and the second side plate 155b to each other. However, the cross-sectional shape and the division structure of the first case 151, the second case 152 and the third case 153 are not limited to the above-mentioned structure and may be varied.

The side plate 155 may include the first side plate 155a of the first case 151, a second side plate 155b of the second case 152, and a third side plate 155c of the third case 153.

The case 150 may be formed of a material having high thermal conductivity, such as a metal. For example, the case 150 may be formed of an aluminum material. The case 150 may emit heat generated in the cell assembly 110 to the outside.

The cell assembly 110 may include a plurality of battery cells 120. In the cell assembly 110, the plurality of battery cells 120 may be configured to be stacked in one direction X. Each of the battery cells 120 may output or store electrical energy.

The battery cell 120 may be configured as a lithium secondary battery, but an embodiment thereof is not limited thereto. For example, the battery cell 120 may be configured as various types of secondary batteries, such as a nickel-cadmium battery, a nickel-metal hydride battery, and a nickel-hydrogen battery. The battery cell 120 may be configured as a pouch-type secondary battery. In the description below, the example in which a pouch-type secondary battery is used as the battery cell 120 will be described. However, in embodiments, a can-type secondary battery such as a prismatic secondary battery or a cylindrical secondary battery may be used as the battery cell 120.

The battery cell 120 may include a cell body portion 121 in which an electrode assembly is accommodated, an electrode lead 122, and a sealing portion 123. The cell body portion 121 may provide an internal space in which an electrode assembly and an electrolyte are accommodated. The electrode assembly may include a plurality of electrode plates and a plurality of electrode tabs and the components may be stored in a pouch. An electrode plate may include a positive plate and a negative plate. The electrode assembly may have a form in which the positive and negative plates are stacked with a separator therebetween in a state in which the relatively wide surfaces of the positive plate and negative plate face each other. Each of the plurality of positive plates and the plurality of negative plates may include electrode tabs. The electrode tabs having the same polarity may be connected to each other and may be connected to an electrode lead 122 having the same polarity. The electrode lead 122 may include a positive lead connected to a positive plate and a negative lead connected to a negative plate.

The sealing portion 123 may be bonded to at least a portion of the circumference of the cell body portion 121 and may form a sealed space in a pouch. The sealing portion 123 may be formed in the form of a flange extending outwardly from the cell body portion 121, formed in a container shape, and may be disposed along an outer edge of the cell body portion 121. The sealing portion 123 may be formed through heat fusion, but the method of forming the sealing portion 123 is not limited thereto.

The cell assembly 110 may include an insertion member 125 disposed between at least a portion of the battery cells 120 among the plurality of battery cells 120.

An insertion member 125 may include a compressible pad and/or an insulating member. The compressible pad may be compressed and elastically deformed when one of the battery cells 120 expands, thereby preventing expansion of the entire volume of the cell assembly 110. To this end, the compressible pad may be configured as foam formed of a polyurethane material, but the material or the structure thereof is not limited thereto.

The insulating member may block flames or high temperature heat energy from spreading between neighboring battery cells 120. Accordingly, the insulating member may prevent chain ignition in the cell assembly 110. The insulating member may include a material having at least one of flame retardancy, heat resistance, insulation, and insulating properties. For example, the insulating member may include a material of at least a portion of mica, silica, silicate, graphite, alumina, ceramic wool, and aerogel, which may prevent the spread of heat and/or flames.

The busbar assembly 130 may electrically connect the battery cells 120 to each other. The busbar assembly 130 may include a busbar 131 which may be electrically conductive and electrically connected to the electrode lead 122 of the battery cell 120 and a busbar frame 135 which may be electrically insulative.

The busbar assembly 130 may be coupled to one surface or both surfaces on which the electrode lead 122 of the battery cell 120 is disposed. The busbar assembly 130 may be coupled to the electrode lead 122 in the direction Y perpendicular to the stacking direction X of the battery cell 120. The electrode lead 122 may penetrate the busbar frame 135. The electrode lead 122 may be electrically connected in series and/or parallel by the busbar 131 on an external side of the busbar frame 135. To this end, a coupling hole 132 through which the electrode lead 122 penetrates and to which the electrode lead 122 is coupled may be formed in the busbar 131. The coupling between the electrode lead 122 and the busbar 131 may be performed by welding in a state in which the electrode lead 122 penetrates the coupling hole 132 and protrudes to an external side of the busbar 131.

The busbar assembly 130 may include a connection terminal 133 for electrical connection with an external entity. Accordingly, the battery cell 120 may be electrically connected to an external entity through the connection terminal 133. The connection terminal 133 may be exposed to the outside of the case 150 through an opening 152a formed in the second case 152.

The busbar frame 135 may be disposed between the cell body portion 121 of the battery cell 120 and the electrically conductive busbar 131 and may support the busbar 131. The busbar frame 135 may include a through-hole 136 through which the electrode lead 122 passes. The electrode lead 122 may pass through the through-hole 136 of the busbar frame 135, may be coupled to the coupling hole 132 formed in the busbar 131 and may be electrically connected to the busbar 131.

The insulating plate 137 may be disposed to prevent the busbar assembly 130 and the case 150 from being electrically short-circuited. The insulating plate 137 may be disposed between the busbar assembly 130 and the case 150 to face the busbar assembly 130. The insulating plate 137 may include an insulating material and may prevent the busbar assembly 130 and the case 150 from being electrically connected to each other. For example, the insulating plate 137 may be formed of an injection-molded plastic product including polypropylene or modified polyphenylene oxide (MPPO). However, the material of insulating plate 137 is not limited thereto. As the insulating plate 137 is disposed, electrical short circuits may be prevented between the cell assembly 110 and the case 150, or between the busbar 131 and the case 150. The insulating plate 137 may include a through-hole 137a through which the connection terminal 133 passes.

A circuit member 141 may be connected to the cell assembly 110 and/or the busbar assembly 130 to obtain information about a temperature and/or voltage from the cell assembly 110 and/or the busbar 131. The circuit member 141 may include a flexible printed circuit board or a printed circuit board. The connection plate 140 may be disposed for installation of the circuit member 141. The connection plate 140 may be disposed on the cell assembly 110. The connection plate 140 may connect the busbar assemblies 130 on both ends of the cell assembly 110. The connection plate 140 may be formed of a material igniting or melting at a predetermined temperature or higher when an event such as thermal runaway occurs. As the connection plate 140, polypropylene, which ignites and/or melts at approximately 160° C., or PVC, which ignites and/or melts at approximately 170° C., but the material is not limited thereto. The connection plate 140 may not be an essential component, and only the circuit member 141 may be installed without the connection plate 140.

The venting portion 160 may be formed in the case 150 to discharge gas generated from the accommodation space S in the case 150 to the outside. At least one venting portion 160 is disposed on at least one of the upper plate 156 or the side plate 155. The venting portion 160 may be formed in at least a portion of the upper plate 156, the side plate 155 and the bottom plate 154.

At least one venting portion 160 may be formed in the case 150. In the case 150, a plurality of venting portion 160 may be provided. Gas, combustion substances, and flames generated when an event occurs may be discharged through the venting portion 160, and “gas” in the embodiments may include combustion substances and flames.

Each of the venting portions 160 may include a hole cover 161 formed on a surface of the case 150 to communicate with the accommodation space S. A first region 162 may be formed in a portion around the hole cover 161. The first region 162 may have a shape formed by cutting out the surface of the case 150. The first region 162 may be formed by press-processing the surface of the case 150. A sealing member 165 covering the first region 162 to prevent gas from flowing through the first region 162 may be disposed. FIGS. 1 and 2 illustrate the shape of the hole cover 161 covering the surface of the case 150, and the hole cover 161 may be lifted toward the external side of the case 150. When the hole cover 161 is lifted, gas discharged to the venting portion 160 may be discharged with directivity. For example, gas discharged to the venting portion 160 may be discharged in a first discharge direction GV1 and/or a second discharge direction GV2.

The hole cover 161 may be integrated with the case 150. For example, the hole cover 161 may be formed by press-processing the case 150. The hole cover 161 may be formed in the case 150 by forming the first region 162 having a cut-out shape formed by press-processing the case 150. According to one embodiment, the hole cover 161 of the venting portion 160 and the case 150 may be integrated with each other, such that the venting portion 160 may be easily formed. The case 150 and the hole cover 161 may be formed of a metal material. The case 150 and the hole cover 161 may be formed of the same material.

A portion of the case 150 in which at least the venting portion 160 is formed may be formed of a metal material. For example, when the venting portion 160 is formed in the upper plate 156, the upper plate 156 may be formed of a metal material. Also, when the venting portion 160 is formed on the side plate 155, the side plate 155 may be formed of a metal material. Since the case 150 is formed of a metal material, heat generated in the accommodation space S in the case 150 may be easily dissipated to the outside of the accommodation space S.

Also, since the case 150 is formed of a metal material, the hole cover 161 may be easily formed by press-processing one portion of the case 150.

In FIGS. 1 and 2, the plurality of venting portions 160 may have the same size and the same shape, but at least a portion of the plurality of venting portions 160 may have a size and a shape different from those of the other venting portions.

The plurality of venting portion 160 may be disposed in a plurality of columns. For example, the plurality of venting portion 160 may include a first venting portion 160a disposed in a column and a second venting portion 160b disposed in a column spaced apart from the first venting portion. In the first venting portion 160a, a plurality of hole cover 161 and a plurality of sealing member 165 may be disposed in a column. In the second venting portion 160b, the plurality of hole cover 161 and the plurality of sealing member 165 may be disposed in a column in a position spaced apart from the first venting portion 160a. The number of columns formed by the plurality of venting portion 160 is not limited to two, or may be one, or may be three or more.

The first discharge direction GV1, the direction in which gas is discharged from the first venting portion 160a, and the second discharge direction GV2, the direction in which gas is discharged from the second venting portion 160b, may be different or may be opposite directions. In this case, by dispersing the gas (including combustion substances and flames) discharged from the accommodation space S in the case 150, concentration of gas, discharged from the plurality of venting portion 160, in a specific portion may be alleviated.

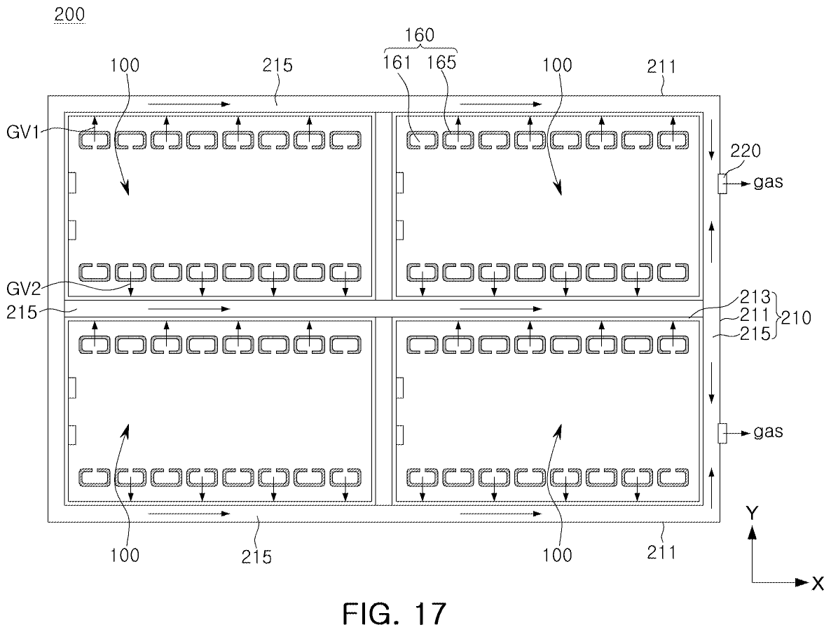

Differently from the above example, the first discharge direction GV1 in which gas is discharged from the first venting portion 160a and the second discharge direction GV2 in which gas is discharged in the second venting portion 160b may be the same. In this case, venting structures for discharging gases (including combustion substances and flames) may be formed in the first discharge direction GV1 and the second discharge direction GV2. For example, when the battery device 100 is configured as a battery module accommodated in a battery pack, a venting structure may be formed in a housing of the battery pack to discharge gas discharged from the battery module to the outside of the battery pack (see 200 in FIG. 17). The venting structure disposed in the housing of the battery pack may include a venting valve.

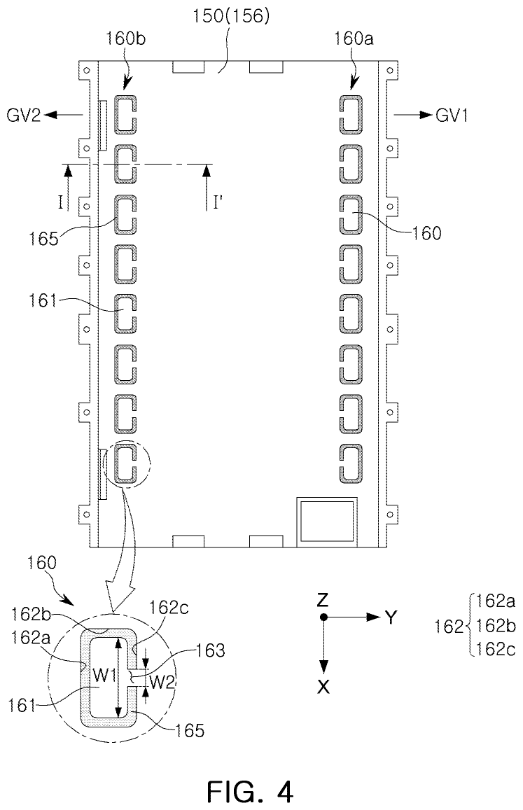

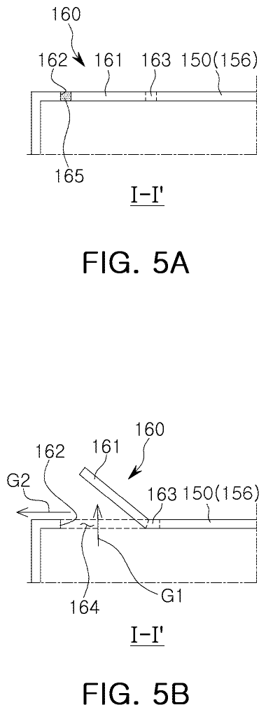

Referring to FIGS. 4 and 5, the venting portion 160 will be described in greater detail. FIG. 4 is a plan diagram illustrating an upper plate 156 and a venting portion 160 illustrated in FIG. 1. FIGS. 5A and 5B are cross-sectional diagrams taken along line I-I′ in FIG. 4. FIG. 5A illustrates a state in which a hole cover 161 is closed, and FIG. 5B illustrates a state in which a hole cover 161 is lifted and a venting hole 164 is formed.

A plurality of venting portion 160 may be disposed on the upper plate 156. At least one venting portion 160 may include a hole cover 161 surrounded by a first region 162 formed by cutting a surface of the case 150 and a second region 163 connected to a surface of the case 110, and a sealing member 165 covering (or filling) the first region 162. The hole cover 161 and the surface of case 150 may be separated from each other by the first region 162. The second region 163 may connect surfaces of the hole cover 161 to the case 150. The first region 162 may be formed by cutting the surface of the case 150. The first region 162 may be formed by cutting the surface of case 150 using press-processing. The hole cover 161 is configured to be lifted from a surface of the case 110 in a direction of an external side of the case 110 and to form a venting hole (164 in FIG. 5B) in the at least one venting portion 160. The second region 163 may work as a reference line along which the hole cover 161 is lifted from the surface of the case 150 when the hole cover 161 is lifted in a direction of an external side of the case 150. When the hole cover 161 is lifted, the venting hole (164 in FIG. 5B) may be formed in a portion surrounded by the first region 162 and the second region 163.

With respect to the direction parallel to the second region 163, a maximum width W1 of the first region 162 may have a value greater than a length W2 of the second region 163 with respect to a direction parallel to the second region 163. When the length W2 of the second region 163 is smaller than the maximum width W1 of the first region 162, the hole cover 161 may be easily lifted from the surface of the case 150. In other words, when the length W2 of the second region 163 is short, the hole cover 161 may easily be folded with respect to the second region 163.

The length W2 of the second region 163 may have a value of 0.1 or more and 0.9 or less with respect to the maximum width W1 of the first region 162. When the length W2 of the second region 163 is less than 0.1 of the maximum width W1 of the first region 162, it may be difficult to maintain rigidity of the hole cover 161 in a state in which the hole cover 161 is lifted from the surface of the case 150. Accordingly, it may be difficult to implement directivity emissions of gas. Alternatively, when the maximum width W1 of the first region 162 exceeds 0.9, the length W2 of the second region 163 may increase, such that a relatively large force may be required to fold the hole cover 161. However, in embodiments, the length W2 of the second region 163 does not exclude the example in which the length exceeds 0.9 of the maximum width W1 of the first region 162.

The first region 162 may include at least a portion of a quadrangular shape. The first region 162 may include three or more sides of a quadrangular shape. The first region 162 may include a portion of three sides and one side of the four sides of the quadrangular shape. For example, the first region 162 may include a first portion 162a facing the second region 163 with a gap therebetween, a second portion 162b extending from each of both ends of the first portion 162a toward the second region 163, and a third portion 162c connecting each of both ends of the second portion 162b to the second region 163. The first portion 162a and the two second portions 162b may form three sides of a quadrangular shape, and the third portion 162c may form a portion of one side of a quadrangular shape. When the first region 162 has the shape described above, the length W2 of the second region 163 may be shortened such that the hole cover 161 may be easily deformed.

As described above, when the hole cover 161 has a quadrangular shape, formability may improve and dimensions may be accurately managed when the hole cover 161 and the first region 162 are formed by press-processing. However, the shapes of the hole cover 161, the first region 162, and the second region 163 are not limited to the aforementioned shapes. For example, the first region 162 may include at least a portion of a circular shape or at least a portion of an elliptical shape in addition to a shape including at least a portion of a quadrangular shape.

The sealing member 165 may seal the first region 162 to prevent gas from flowing through the first region 162 in a state in which the hole cover 161 is not lifted from the surface of the case 150.

The sealing member 165 may close the first region 162, and may prevent external moisture or foreign substances from flowing into the case 150 through the first region 162 having the cut-out shape. In addition to the function of closing the first region 162, the sealing member 165 may partially limit deformation of the hole cover 161.

The sealing member 165 may be configured to open at least a portion of the first region 162 when a temperature of the sealing member 165 reaches a set temperature or higher or when the pressure applied to the sealing member 165 reaches a set pressure or higher. When the sealing member 165 opens at least a portion of the first region 162, the hole cover 161 may be easily deformed in a direction of an external side in the case 150.

The sealing member 165 may be formed of a material (e.g., synthetic resin) igniting or melting at a predetermined set temperature or higher when an event such as thermal runaway occurs.

For example, the sealing member 165 may include a material igniting or melting at 100°° C. or higher and 400° C. or lower. When the ignition and/or melting temperature of the sealing member 165 is lower than 100° C., the first region 162 may open even when no event occurs. In this case, external moisture or foreign substances may enter the case 150 through the first region 162. Alternatively, when the ignite and/or melting temperature of the sealing member 165 exceeds 400° C., gas in the case 150 may not be easily discharged to the outside. That is, when an event occurs, when the sealing member 165 closes the first region 162, the sealing member 165 may limit the deformation of the hole cover 161, such that there may be limitation in gas discharge.

The sealing member 165 may include polypropylene (PP), which ignites and/or melts at approximately 160° C. As polypropylene may be light-weighted, may have a low reduction rate, and may be electrically insulative, polypropylene may be suitable for the sealing member 165. Also, the sealing member 165 may include polyvinyl chloride (PVC), which ignites and/or melts at approximately 170° C. However, the material of the sealing member 165 is not limited thereto and may be varied when the material may be melted and/or ignited in a specific temperature range.

Referring to FIG. 5A, the sealing member 165 may have a shape filling the first region 162. However, the sealing member 165 may have a sheet shape covering an upper portion and/or a lower portion of the first region 162.

When an event occurs, the hole cover 161 may be folded in a direction of an external side of the case 150 with respect to the second region 163, and accordingly, the hole cover 161 may open the venting portion 160. When the hole cover 161 is lifted in a direction of an external side of the case 150, a venting hole 164 may be formed in the venting portion 160. The venting hole 164 may be formed by a portion surrounded by the first region 162 and the second region 163 when the hole cover 161 is lifted.

FIG. 5B illustrates a state in which the sealing member 165 is removed as the sealing member 165 is melted and/or ignited when an event occurs. Alternatively, at least a portion of the sealing member 165 may remain in the first region 162 when the hole cover 161 is open. In other words, the hole cover 161 may be folded in a direction of an external side of the case 150 with respect to the second region 163 by pressure in the case 150 even before the sealing member 165 is melted and/or ignited.

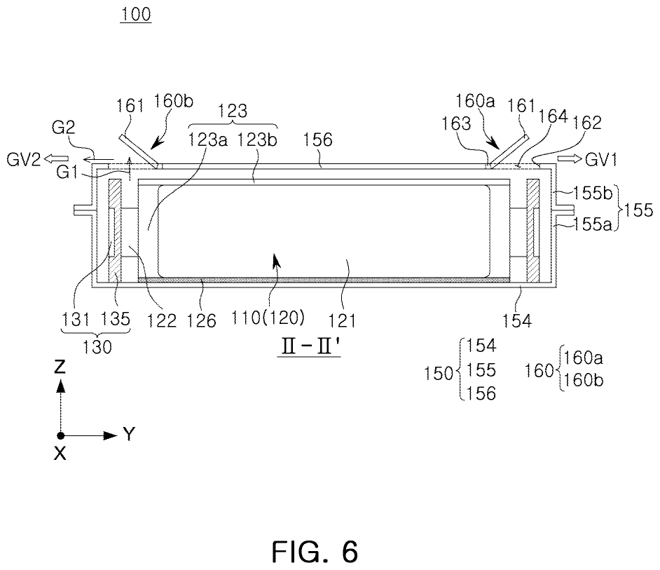

FIG. 6 is a cross-sectional diagram taken along line II-II′ in FIG. 1, illustrating a state in which a hole cover 161 is lifted in a direction of an external side of a case 150. FIG. 6 illustrates only the main components for ease of description.

Referring to FIG. 6, a sealing portion 123 of a battery cell 120 may include a first sealing portion 123a disposed in a region in which an electrode lead 122 is disposed, and a second sealing portion 123b disposed in a region in which the electrode lead 122 is not disposed. In an embodiment in FIG. 6, the sealing portion 123 may not be formed on a lower surface of the battery cell 120.

When an event occurs in the battery cell 120, gas (including flames and combustion substances) may be discharged through the sealing portion 123. Accordingly, the venting portion 160 may be disposed in a region adjacent to the sealing portion 123. For example, the venting portion 160 may be formed on the upper plate 156.

When an event occurs, a hole cover 161 may be lifted in a direction of an external side with respect to the second region 163 of a case 150 and may form a state in which the venting hole 164 is open.

Gas generated in an accommodation space S may move in a first direction G1 through the venting hole 164, may change a direction thereof by hitting the hole cover 161, and may be discharged in the second direction G2. In other words, the hole cover 161 may guide directivity discharge of gas such that the gas in the case 150 may be discharged in the second direction G2.

The hole cover 161 may have a shape lifted in the second direction G2 such that gas passing through the venting hole 164 in a first direction G1 is discharged in the second direction G2 in the state in which the venting hole 164 is open. The second direction G2 is different from the first direction G1. In the prior art in which the hole cover 161 is not provided, the gas discharged through the venting hole 164 may be discharged in an arbitrary direction. However, according to an embodiment, the hole cover 161 may be configured to be lifted in the second direction G2 with respect to the second region 163, such that gas may be discharged with directivity. Accordingly, the gas discharged to the outside of the case 150 may be easily controlled. For example, the gas discharged from the case 150 may be easily processed through a venting structure or a gas processing structure.

As illustrated in FIG. 6, the venting portion 160 may be formed in an upper plate 156. The venting portion 160 may include a first venting portion 160a and a second venting portion 160b formed on the upper plate 156. Gas discharged from the first venting portion 160a may be discharged in a first discharge direction GV1, and gas discharged from the second venting portion 160b may be discharged in a second discharge direction GV2. The first discharge direction GV1 and the second discharge direction GV2 may be different. For example, the first discharge direction GV1 and the second discharge direction GV2 may be opposite directions.

The cell assembly 110 including a plurality of battery cells 120 may be installed on a bottom plate 154. A heat transfer member 126 may be disposed between the cell assembly 110 and the bottom plate 154 such that heat generated in the cell assembly 110 may be easily dissipated through the bottom plate 154. One side of the heat transfer member 126 may be in contact with a lower surface of the battery cell 120, and the other side of the heat transfer member 126 may be in contact with the bottom plate 154. The heat transfer member 126 may include at least a portion of thermal grease, thermal adhesive, thermally conductive epoxy, a heat dissipation pad to smoothly perform heat transfer, but an embodiment thereof is not limited thereto. The heat transfer member 126 may be disposed in the form of a pad between a lower surface of the battery cell 120 and a top surface of the bottom plate 154, or may be formed by applying a material in a liquid or gel state. The heat transfer member 126 may also be configured to have high insulating properties, for example, a substance having a dielectric strength in the range of 10 to 30 KV/mm may be used. When a highly insulating substance is used as the heat transfer member 126, even when the insulation is partially failed in the battery cell 120, the insulation between the battery cell 120 and the case 150 may be maintained by the heat transfer member 126 disposed around the battery cell 120.

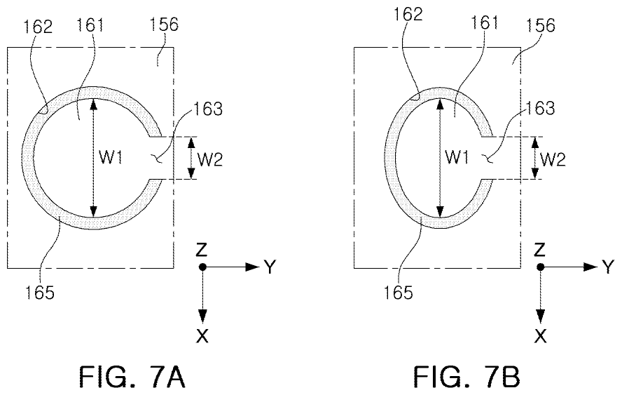

FIGS. 7A and 7B are plan diagrams illustrating a modified example of a venting portion 160 illustrated in FIG. 4.

Referring to FIGS. 7A and 7B, a hole cover 161 surrounded by a first region 162 and a second region 163, and a sealing member 165 covering the first region 162 may be included.

The first region 162 may include at least a portion of a circular shape as illustrated in FIG. 7A and at least a portion of an elliptical shape as illustrated in FIG. 7B. With respect to a direction parallel to the second region, a maximum width W1 of the first region 162 may have a value greater than a length W2 of the second region 163. When the length W2 of the second region 163 is smaller than the maximum width W1 of the first region 162, the hole cover 161 may be easily lifted from a surface of the upper plate 156. In other words, when the length of second region 163 is shorter than the width of first region 162, the hole cover 161 may easily be folded with respect to the second region 163.

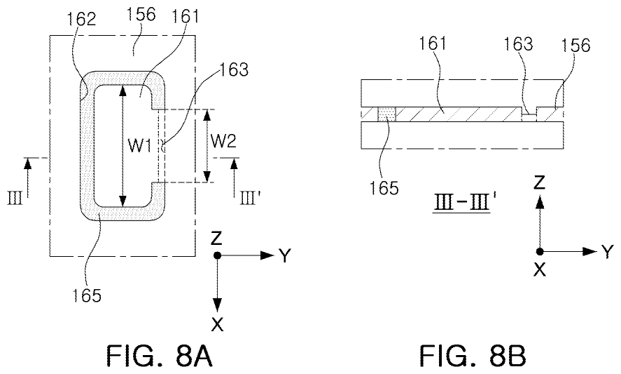

FIGS. 8A and 8B are diagrams illustrating another modified example of a venting portion 160 illustrated in FIG. 4, and FIG. 8A is a plan diagram, and FIG. 8B is a cross-sectional diagram taken along line III-III′.

Referring to FIGS. 8A and 8B, at least a portion of a second region 163 of the venting portion 160 may have a thickness smaller than a thickness of the case (150 in FIG. 4). When the second region 163 has a reduced thickness as above, the hole cover 161 may easily be folded toward an external side of the upper plate 156 with respect to the second region 163.

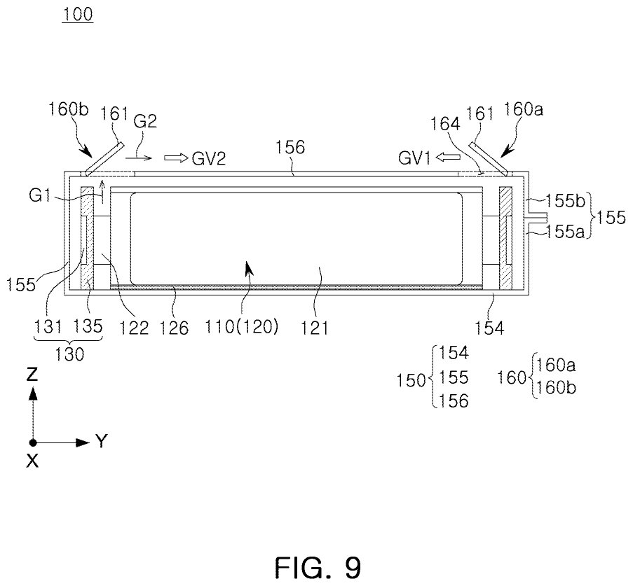

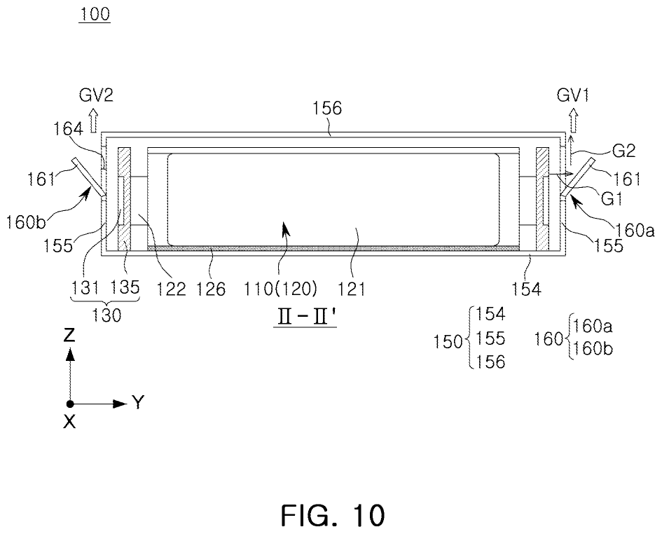

FIGS. 9 and 10 are cross-sectional diagrams each illustrating a modified example in FIG. 6.

As described with respect to FIG. 6, when an event occurs in a battery cell 120, gas (including flames and combustion substances) may be discharged through a sealing portion 123. Accordingly, a venting portion 160 may be disposed in a region adjacent to the sealing portion 123. Since the modified examples in FIGS. 9 and 10 are different from the examples in FIG. 6 only in terms of the installation position and the discharge direction of the venting portion 160, the detailed descriptions thereof may not be provided and only the differences will be described.

When the first sealing portion 123a opposes to the side plate 155 and the second sealing portion 123b opposes to the upper plate 156, the first venting portion 160a and the second venting portion 160b may be disposed on at least one of the upper plate 156 and/or the side plate 155.

In the embodiment illustrated in FIG. 9, the first venting portion 160a and the second venting portion 160b may be formed on the upper plate 156, respectively, and a first discharge direction GV1 and a second discharge direction GV2 may be disposed to be directed in opposite directions. The first discharge direction GV1 and the second discharge direction GV2 may oppose each other with respect to a center of the case 150.

In the embodiment illustrated in FIG. 10, the venting portion 160 may be formed on at least one of side plates 155. The first venting portion 160a may be formed on a side plate 155 on one side, and the second venting portion 160b may be formed on a side plate 155 on the other side opposing the first venting portion 160a.

Referring to FIG. 10, the first discharge direction GV1 in which gas is discharged from the first venting portion 160a and the second discharge direction GV2 in which gas is discharged in the second venting portion 160b may be the same. For example, the first discharge direction GV1 and the second discharge direction GV2 may both be directed upwardly (+Z axis). However, the first discharge direction GV1 and the second discharge direction GV2 are not limited thereto and may be directed downward, forward, or backward. Also, the first discharge direction GV1 and the second discharge direction GV2 may be different.

Although not illustrated, the venting portion 160 may be installed on both the upper plate 156 and the side plate 155 adjacent to the sealing portion 123. For example, the first venting portion 160a may be disposed on one of the upper plate 156 and the side plate 155, and the second venting portion 160b may be disposed on the other of the upper plate 156 and the side plate 155.

However, the installation position, the number of venting portion 160 installed, and the discharge direction of the venting portion 160 may be varied to control processing of the discharged gas in the case 150.

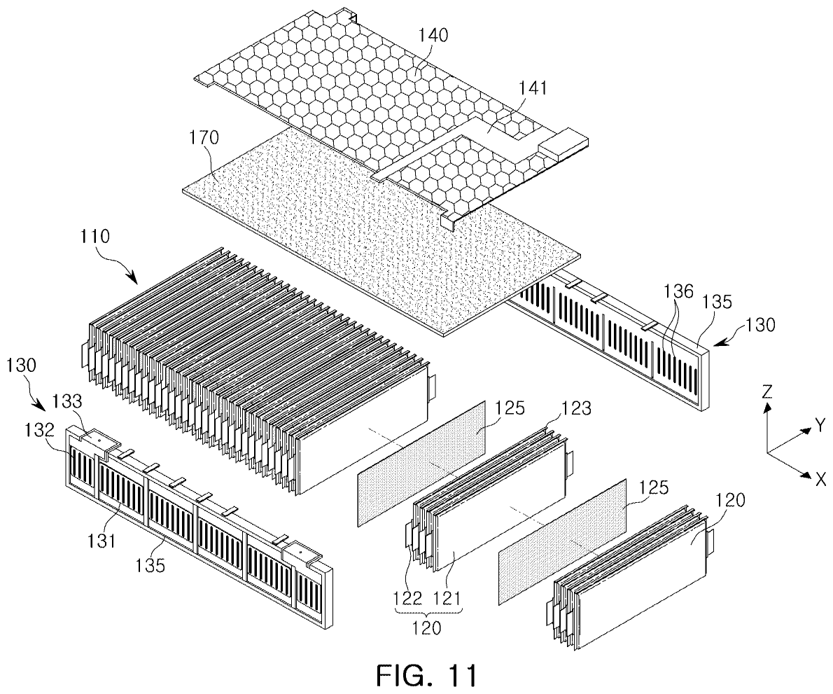

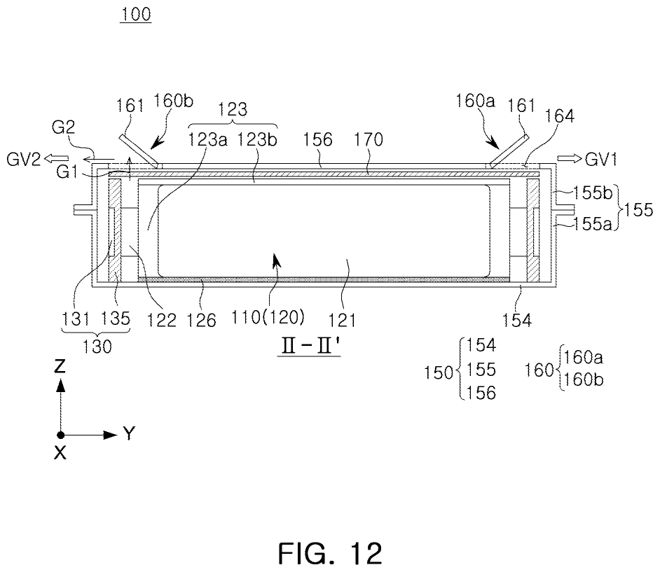

FIG. 11 is an exploded perspective diagram illustrating a modified example in FIG. 3. FIG. 12 is a cross-sectional diagram illustrating another modified example of FIG. 6, illustrating a cross-section of the component illustrated in FIG. 11.

The only difference between the embodiments in FIGS. 11 and 12 and the embodiments in FIGS. 3 and 4 is the configuration in which the blocking member 170 is disposed between the cell assembly 110 and the upper plate 156. Accordingly, the detailed descriptions of the same or similar components will not be provided.

The blocking member 170 may be disposed between the cell assembly 110 and at least one venting portion 160 and may delay or prevent flames from being discharged through the venting portion 160. The blocking member 170 may be disposed to oppose the cell assembly 110 between the cell assembly 110 and the venting portion 160. For example, as illustrated in FIGS. 11 and 12, the blocking member 170 may cover an upper side of the cell assembly 110.

The blocking member 170 may prevent or reduce flames generated in an accommodation space S from being exposed to the outside through the venting portion 160. The blocking member 170 may include at least one of porous metal foam and metal mesh. The blocking member 170 may be formed of a flame-retardant and heat-resistant material. For example, porous metal foam or metal mesh may include a metal material having a melting point of 1000° C. or higher.

Also, the blocking member 170 may function as an insulating member blocking flames or high-temperature heat energy generated in the accommodation space S from being transferred to the outside. The blocking member 170 used as an insulating member may include at least a portion of a material selected from a group consisting of mica, silica, silicate, graphite, alumina, ceramic wool, and aerogel.

However, the material of the blocking member 170 is not limited to the materials described above, and various generally used materials may be used.

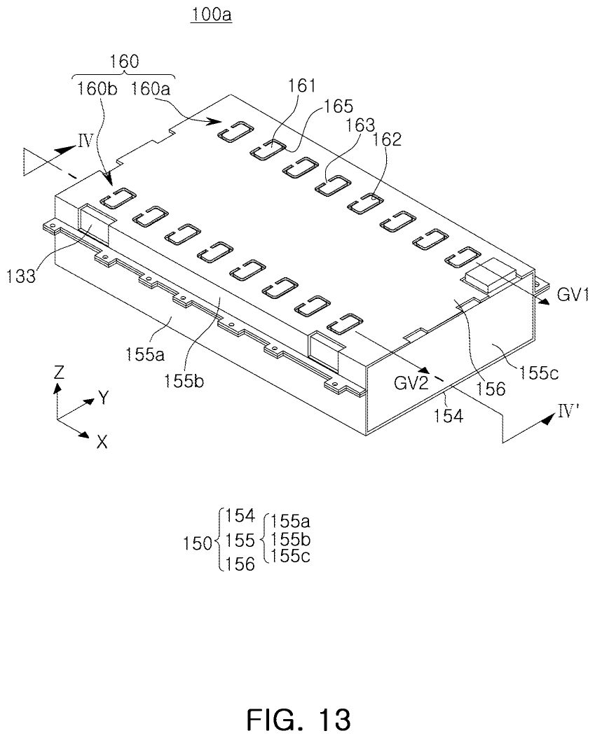

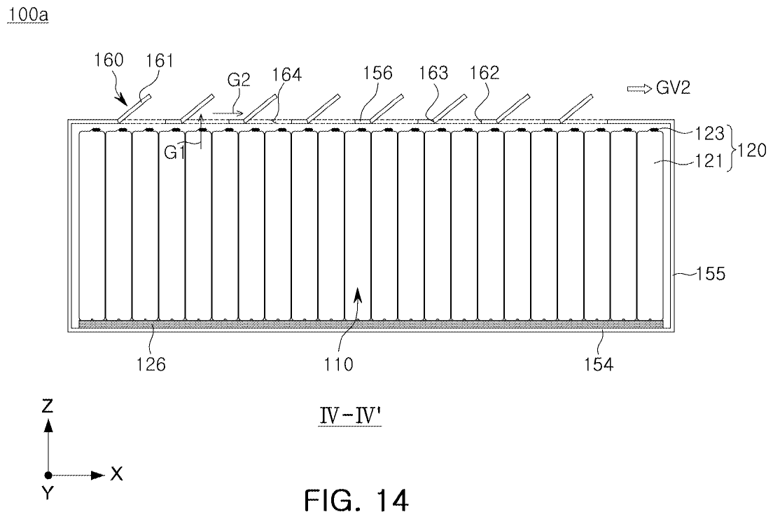

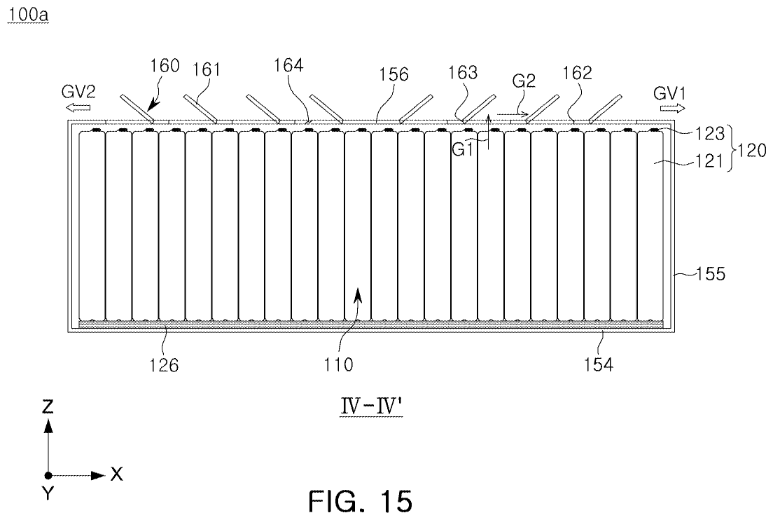

FIG. 13 is a perspective diagram illustrating a battery device 100a according to another embodiment. FIG. 14 is a cross-sectional diagram taken along line IV-IV′ in FIG. 13. FIG. 15 is a cross-sectional diagram illustrating modified example in FIG. 14.

The embodiment illustrated in FIGS. 13 to 15 illustrates a configuration in which a venting portion 160 is formed in an upper plate 156, similarly to the embodiment illustrated in FIGS. 1 to 6. However, the discharge direction of the venting portion 160 in the embodiment illustrated in FIGS. 13 to 15 may be different from the embodiment illustrated in FIGS. 1 to 6.

Referring to FIGS. 13 and 14, at least one venting portion 160 includes a plurality of venting portions 160. The plurality of venting portion 160 may include a first venting portion 160a having a first discharge direction GV1 and a second venting portion 160b having a second discharge direction GV2. The direction in which the hole cover 161 is lifted from the first venting portion 160a and the direction in which the hole cover 161 is lifted from the second venting portion 160b and the gas is discharged may be disposed to be directed in the same direction (+X axis). A plurality of venting portions 160 are configured such that gas discharged from each of the venting portions 160 is directed in the same direction. That is, the first discharge direction GV1 of the first venting portion 160a and the second discharge direction GV2 of the second venting portion 160b may be the same direction.

Differently from FIG. 14, the embodiment illustrated in FIG. 15 illustrates a configuration in which the first discharge direction GV1 and the second discharge direction GV2 are disposed to be directed in opposite directions.

The installation position, the number of the venting portion 160 installed, and discharge direction of the venting portion 160 may be varied to control the processing of the discharged gas in the case 150.

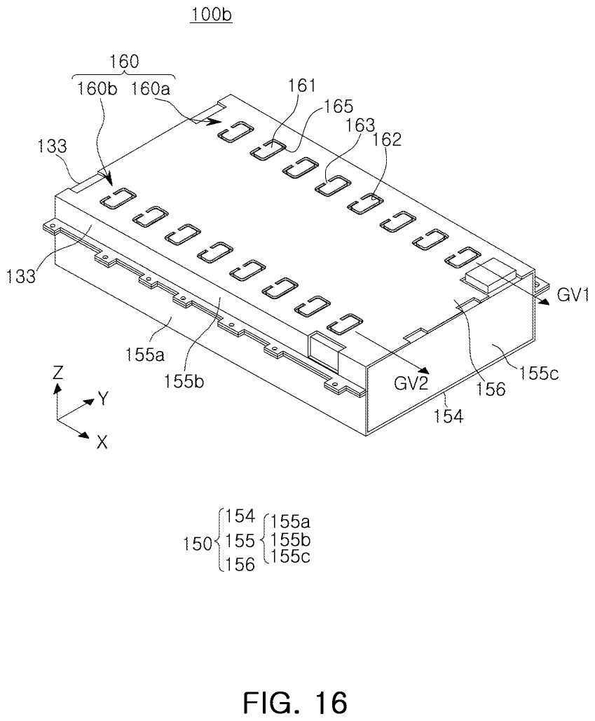

FIG. 16 is a perspective diagram illustrating a battery device 100b according to another embodiment.

As compared to an embodiment illustrated in FIG. 13, an embodiment illustrated in FIG. 16 may be different only in terms of the configuration in which the position in which the connection terminal 133 of the busbar assembly 130 is disposed.

The connection terminal 133 may electrically connect a busbar 131 to an external component (for example, another battery module or vehicle component). The connection terminal 133 may be configured to input and output high-voltage, and a high-voltage busbar 131 may be connected to the connection terminal 133. The high-voltage busbar 131 may electrically connect the connection terminal 133 to other external components.

Since the gas discharged through the venting portion 160 has high temperature, when the high temperature gas is discharged to the connection terminal 133 or the high-voltage busbar 131, an additional fire may occur due to a short circuit, or the like.

Accordingly, as in an embodiment illustrated in FIG. 16, the venting portion 160 may be disposed such that gas discharged from the venting portion 160 is not directed toward the connection terminal 133. The gas discharge directions GV1 and GV2 of the venting portion 160 may be directed in the opposite direction (+X) in which the connection terminal 133 is disposed.

FIG. 17 is a plan diagram illustrating a battery system 200 according to an embodiment.

As illustrated in FIG. 17, the battery system 200 may include a housing 210 in which an internal space is formed and a plurality of battery devices 100 accommodated in the housing 210.

The battery system 200 in FIG. 15 illustrates the battery device 100 in FIG. 1 as an example, but the battery system 200 according to an embodiment may include the battery device 100 having various structures described with reference to FIGS. 1 to 16. In an embodiment in FIG. 17, the battery system 200 may correspond to a battery pack, and the plurality of battery devices 100 may correspond to a battery module.

The housing 210 may include a side frame 211 disposed around the housing. The battery device 100 may be disposed in an internal space formed by the side frame 211. The housing 210 may include a cross frame 213 partitioning the internal space. The plurality of battery devices 100 may be disposed in the spaces partitioned by the cross frame 213, respectively.

The housing 210 may include at least one gas flow path 215 through which gas discharged from the venting portion 160 of the battery device 100 flows. The gas flow path 215 may be disposed in at least a portion of the side frame 211 and the cross frame 213. The housing 210 may include a bottom frame disposed below the side frame 211 and a cover disposed on the side frame 211. The gas flow path 215 may include a flow path passing through the bottom frame and/or the cover.

The venting portion 160 may be disposed such that gas discharged from the venting portion 160 may flow through the gas flow path 215. When the sealing member 165 is released and the hole cover 161 is lifted, gas in the battery device 100 may be discharged. In this case, the venting portion 160 may be disposed such that gas discharged from the battery device 100 may flow toward the gas flow path 215 formed in the side frame 211 and/or the cross frame 213. For example, the venting portion 160 on one side may be disposed such that the discharged gas may flow toward the first discharge direction GV1, and the venting portion 160 on the other side may be disposed such that the discharged gas may flow toward the second discharge direction GV2. The first discharge direction GV1 and the second discharge direction GV2 may be directed in opposite directions, or may be directed in the same direction.

The housing 210 may include at least one gas discharge unit 220 through which gas is discharged. The gas discharge unit 220 may discharge gas generated in the housing 210 to the outside of the housing 210. The gas discharge unit 220 may be disposed to communicate with the gas flow path 215. The gas discharge unit 220 may be installed on the side frame 211, or may be installed on the cover or the bottom frame. The installation position of the gas discharge unit 220 and the number of gas discharge unit 220 may be varied.

The gas discharge unit 220 may include a hole configured to be open. Differently from the above example, the gas discharge unit 220 may be configured to be open when pressure or temperature in the housing 210 increases a set value or higher. The gas discharge unit 220 may include a valve configured to be open at a set pressure or higher or a set temperature or higher.

The venting portion 160 of the battery device 100 may be configured to have a direction in which gas discharged from the venting portion 160 flows to at least one gas discharge unit 220.

According to the aforementioned embodiments, by allowing gas discharged through the venting portion to have directivity, the influence of gases (including flames and combustion substances) generated from the cell assembly disposed in the battery device on the outside of the battery device may be reduced or prevented.

Also, secondary ignition and/or thermal runaway of a cell assembly may be delayed or prevented.

Only specific examples of implementations of certain embodiments are described. Variations, improvements and enhancements of the disclosed embodiments and other embodiments may be made with respect to the disclosure of this patent document.

What is claimed is:

1. A battery device, comprising:
a cell assembly including a plurality of battery cells;
a case accommodating the cell assembly; and
at least one venting portion in the case to discharge gas generated from the cell assembly to the outside of the case;
wherein the at least one venting portion includes a hole cover surrounded by a first region formed by cutting a surface of the case and a second region connected to a surface of the case, and a sealing member covering the first region,
wherein the hole cover is lifted from a surface of the case in a direction of an external side of the case and comprises a venting hole in the at least one venting portion, and
wherein the sealing member seals the first region to prevent gas from flowing through the first region in a state in which the hole cover covers the venting hole.

2. The battery device of claim 1, wherein the venting hole is in a portion surrounded by the first region and the second region when the hole cover is lifted.

3. The battery device of claim 1, wherein the hole cover is folded in a direction of an external side of the case with respect to the second region.

4. The battery device of claim 1, wherein the sealing member includes a material ignited or melting at 100° C. or higher and 400° C. or lower.

5. The battery device of claim 1, wherein the sealing member includes polypropylene (PP) or polyvinyl chloride (PVC).

6. The battery device of claim 1, wherein the sealing member opens the first region when a temperature of the sealing member reaches a set temperature or higher or when pressure applied to the sealing member reaches a set pressure.

7. The battery device of claim 1, wherein a maximum width of the first region has a value greater than a length of the second region with respect to a direction parallel to the second region.

8. The battery device of claim 7, wherein a length of the second region has a value of 0.1 or more and 0.9 or less with respect to a maximum width of the first region.

9. The battery device of claim 1, wherein the first region includes a first portion facing the second region with a gap therebetween, a second portion extending from both ends of the first portion toward the second region, and a third portion connecting both ends of the second portion to the second region.

10. The battery device of claim 1, wherein the first region includes at least a portion of a quadrangular shape, at least a portion of a circular shape, or at least a portion of an elliptical shape.

11. The battery device of claim 1, wherein at least a portion of the second region has a thickness smaller than that of the case.

12. The battery device of claim 1, wherein the hole cover and the first region are formed by press-processing the case.

13. The battery device of claim 1, wherein the hole cover has a shape lifted in a second direction such that gas passing through the venting hole in a first direction is discharged in the second direction in the state in which the venting hole is open, and the second direction is different from the first direction.

14. The battery device of claim 1,
wherein the case includes an upper plate covering an upper portion of the cell assembly and a side plate covering a side surface of the cell assembly, and
wherein the at least one venting portion is disposed on at least one of the upper plate or the side plate.

15. The battery device of claim 14,
wherein the at least one venting portion includes a plurality of venting portions, and
wherein the plurality of venting portions are configured such that gas discharged from each of the venting portions is directed in the same direction.

16. The battery device of claim 14,
wherein the at least one venting portion includes a plurality of venting portions, and
wherein the plurality of venting portions include a first venting portion disposed in a column, and a second venting portion disposed in a column in a position spaced apart from the first venting portion.

17. The battery device of claim 16, wherein a first discharge direction in which gas discharged from the first venting portion is directed and a second discharge direction in which gas discharged from the second venting portion is directed are opposite directions.

18. The battery device of claim 1, further comprising:
a busbar assembly including a plurality of busbars electrically connecting the plurality of battery cells to each other, and a connection terminal connecting at least a portion of the plurality of busbars to an external entity,
wherein the at least one venting portion is disposed such that gas discharged from each venting portion is not directed toward the connection terminal.

19. The battery device of claim 1, further comprising:
a blocking member disposed between the cell assembly and the at least one venting portion and delaying or preventing flames from being discharged through the at least one venting portion.

20. A battery system, comprising:
a housing including an internal space formed therein; and
a plurality of battery devices accommodated in the housing,
wherein each of the plurality of battery devices includes:
a cell assembly including a plurality of battery cells;
a case accommodating the cell assembly; and
at least one venting portion in the case to discharge gas generated from the cell assembly to the outside of the case,
wherein the at least one venting portion includes a hole cover surrounded by a first region formed by cutting a surface of the case and a second region connected to a surface of the case, and a sealing member covering the first region, and
wherein the hole cover is lifted from a surface of the case in a direction of an external side of the case and comprises a venting hole in the at least one venting portion, and
wherein the sealing member seals the first region to prevent gas from flowing through the first region in a state in which the hole cover covers the venting hole.
